(19) United States
(12) Patent Application Publication
(10) Pub. No.: US 2021/0368250 A1
(43) Pub. Date: Nov. 25, 2021

(54) METHOD OF MAKING A MONOLITHIC MULTI-TONE AUDIO SPEAKER COVER AND PRODUCT MADE THEREBY

(71) Applicant: OAKWOOD METAL FABRICATING CO., Dearborn, MI (US)

(72) Inventors: Donald Scott SMITH, Commerce, MI (US); Richard Francois AUDI, Dearborn, MI (US); Joel Matthew CORMIER, Lathrup Village, MI (US)

(21) Appl. No.: 17/395,896

(22) Filed: Aug. 6, 2021

Related U.S. Application Data
(63) Continuation-in-part of application No. 16/752,437, filed on Jan. 24, 2020.
Application No. 16/752,437 is a continuation-in-part of application No. 29/721,986, filed on Jan. 24, 2020.

(51) Int. Cl. H04R 1/02; H04R 31/00; B05D 5/06; B05D 7/00; B05D 1/32

(52) U.S. Cl. CPC H04R 1/023; H04R 31/00; B05D 1/32; B05D 7/57; B05D 5/066

(57) ABSTRACT

A method of making a monolithic multi-tone audio speaker cover and the product made thereby. The method involves creating a hole pattern in a blank; providing a ditch inside a periphery of the blank; forming a shape in the blank to make a shaped blank; treating or painting at least some of the surface of the shaped blank with a primary treatment or color to prepare a treated or painted shaped blank; masking an area of the treated or painted shaped blank with a masking material along a portion of the ditch to cover at least a portion of the treated or painted shaped blank; and applying a secondary color to the unprotected area. The audio speaker cover made thereby has a distinct unwavering separation between the respective treated areas that is visually pleasing.

### CROSS REFERENCE TO RELATED APPLICATIONS

This application is a continuation-in-part of co-pending U.S. application Ser. No. 16/752,437, filed on Jan. 24, 2020 and U.S. Design APPLICATION Ser. No. 29/721,986, also filed on Jan. 24, 2020 which are incorporated herein by reference.

### TECHNICAL FIELD

The present disclosure relates to a monolithic or one-piece multi-tone audio speaker cover.

### BACKGROUND ART

An audio speaker cover is often one of the first objects that an observer sees when looking toward a source of sound. The speaker cover is often in the front of many consumer, automotive and industrial speakers that are designed to propagate sound. Even when silent, the audio speaker cover usually contributes one way or another to an overall visual impression of an environment of use.

Speakers are typically housed in a speaker enclosure, casing or cabinet. The enclosure's materials and design influence the quality of the sound. The enclosure generally must be as stiff and non-resonant as practically possible.

The audio speaker cover usually has a hard or soft screen that is mounted in front of the face of a speaker driver. Its main purpose is to protect internal speaker components from damage while allowing sound to pass without excessive loss or distortion. However, because the cover lies in the path of the sound waves, conventional speaker covers inevitably influence the sound produced, often detrimentally.

A balance is therefore sought between ability to protect the speaker and sound quality. If the cover is massive, sound quality is impaired. But potentially ugly components may be effectively masked from view. On the other hand, if the cover is too flimsy, unsightliness may result. However sound quality may be relatively unaffected.

Against such design challenges, audio speaker covers have been manufactured from a variety of materials. They include fabric, thermoplastics, thermosets, perforated metal, expanded metal, woven wire and the like. Certain materials such as fabric may be thin and have a large open area percentage. This may be ideal for sound transmission. But these materials lack the ability to adequately protect the speaker assembly in environments where human contact and abuse is anticipated. Examples include home audio systems, electronic devices, computers, microphones, portable speakers, and transportation-related audio systems such as cars, trucks, boats, aircraft, and the like.

In such applications, substantially rigid audio speaker covers are deployed adjacent to the speaker itself to protect the fragile speaker cone and assembly from damage. Additionally, since these systems are in proximity to the audiophile, visual styling and aesthetics are also necessary to produce a cost-effective yet attractive means of protecting the speaker itself.

Speaker covers may be injection molded from thermoplastics. However, plastics have a lower strength-to-weight ratio compared to metal speaker covers and therefore require substantially more thickness than a metal cover to protect the speaker assembly.

Metal speaker covers have historically offered superior sound transmission characteristics compared to plastic speaker covers due to their high strength-to-weight ratio. Metal audio covers can be produced from a variety of metals including woven metal wire and with sheets of metal which are subject to a variety of processes to create apertures for sound transmission. These sheet-based processes include metal expanding, punch perforating, laser cutting, water jet cutting, photochemical etching, and powdered metal laser sintering. Sheets of these materials with apertures are then converted in finished goods using traditional metal forming techniques, combined with a variety of coating, and finishing techniques. However, the finished speaker cover needs to be visually pleasing to the audiophile. The penalty for adding a conventional speaker cover is always the amount of sound transmission loss due to the solid or the non-open areas of the rigid speaker cover that protects the speaker.

The ideal audio speaker cover is both attractive and cost effective to manufacture, along with providing adequate strength that withstands normal abuse and offers the lowest possible sound transmission loss. Metal speaker covers have traditionally offered the best balance of strength and lower levels of sound transmission loss than compared to injection molded speaker covers.

### SUMMARY

In several aspects, this disclosure includes a method of making a one-piece, multi-tone audio speaker cover. In broad terms, one way to do this is by following such steps as:
a. creating a hole pattern in a blank and treating the blank if desired to impart a desired surface finish, tone or color (collectively hereinafter “multi-tone”);
b. forming a shape in the blank to make a shaped blank;
c. creating a ditch or angular trough in an outer face of the shaped blank proximate a periphery thereof, thereby creating an inboard area of the shaped blank that is separated by the ditch from an outboard area thereof;
d. treating at least some of the outer face of the shaped blank with a primary treatment, tone or color to prepare a treated shaped blank;
e. masking an area of the treated shaped blank with a masking material having an edge that is juxtaposed with a portion of the ditch to cover at least a portion of the treated shaped blank, thereby defining a protected area of the shaped blank that underlies the masking material and an unprotected area of the shaped blank separated by the ditch;
f. applying a secondary treatment, tone or color to the unprotected area;
g. optionally, re-masking, re-treating and/or re-painting if one or more additional surface treatments, tones or colors are required; and
h. removing the masking material without deteriorating an underlying surface of the treated shaped blank to which the masking material is removably affixed to define in the audio speaker cover a distinct, crisply defined border between the primary and secondary treated, toned or colored areas.

Multi-toned audio speaker covers made by such process steps can be made quickly, in batches, be of consistent quality and (1) have a surface that is free of blemishes or deformation; (2) are visually pleasing; and (3) are of one-piece construction. As a result of one-piece construction, manufacturing efficiencies are realized. Further, the audio speaker cover is relatively immune to problems of squeaks and rattles that often accompany multi-piece assemblies of audio speaker covers (e.g. at a chrome border of a conventional cover). In practice the resulting product may look like a multi-part speaker cover but is not. It is monolithic.

The above advantage and other advantages and features of the present disclosure will be readily apparent from the following detailed description of the preferred embodiments when taken in connection with the accompanying drawings.

### BRIEF DESCRIPTION OF THE DRAWINGS

FIGS. 1 A-C include a side view of a planar blank (FIG. 1 A) from which an audio speaker cover is to be made before shaping which includes an enlargement of a ditch situated around a periphery of the audio speaker cover, a plan view (FIG. 1 B) of a shaped audio speaker cover and a sectional view thereof (FIG. 1 C) which also includes an enlargement of a ditch situated around a periphery of the audio speaker cover;

FIG. 2 is a representative method of making process flow diagram (Steps a-g);

FIG. 3 is a plan view of an audio speaker cover upon which an alternative masking approach is used;

FIG. 4 is a perspective sectional view of a finished audio speaker cover which includes the ditch situated around a periphery of the audio speaker cover;

FIGS. 5 A-C include fragmented sectional views of alternative ditch-masking configurations;

FIG. 6 is a perspective view of one embodiment of a multi-tone audio speaker cover with masking material removed;

FIG. 7 is a top plan view thereof;

FIG. 8 is a bottom plan view thereof.

FIG. 9 is a left side elevational view thereof;

FIG. 10 is a right side elevational view thereof;

FIG. 11 is a front elevational view thereof; and

FIG. 12 is a rear elevational view thereof.

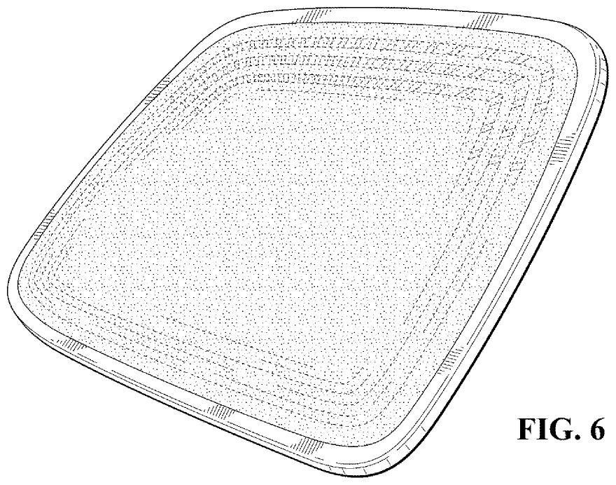

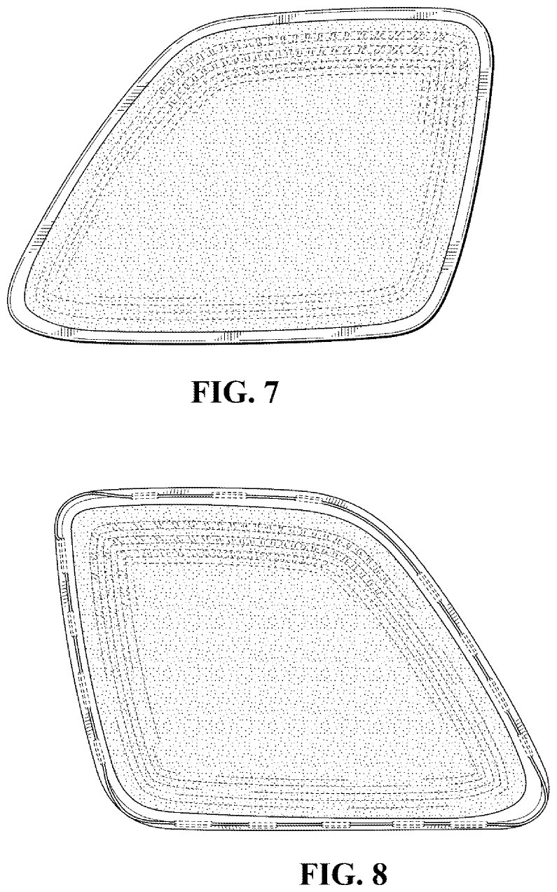

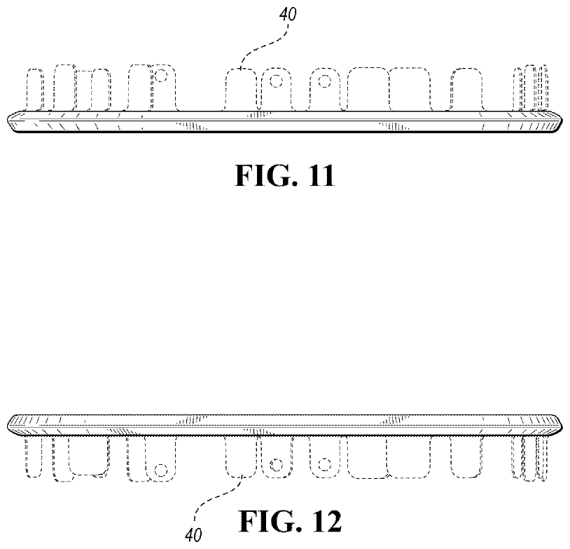

FIGS. 6-12 include surface shading which suggests that there is different color, tone, shading, surface and/or ornamentation between a central region and a peripheral region of the audio speaker cover. In this context, the audio speaker cover can be considered as having two or more colors, tones, shadings, surfaces and/or ornamentations, which form part of the claimed structure.

The stippled shading in FIGS. 6-12 between the central region and the peripheral region of the audio speaker cover is understood in the depicted embodiment to represent a contrast in color, tone, shading and/or ornamentation.

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of components. Therefore, specific structural and functional details disclosed herein are not to be interpreted as limiting, but merely as a representative basis for teaching one skilled in the art to variously employ the present invention.

As those of ordinary skill in the art will understand, various features of the present invention as illustrated and described with reference to any one of the Figures may be combined with features illustrated in one or more other Figures to produce embodiments of the present disclosure that are not explicitly illustrated or described. The combinations of features illustrated provide representative embodiments for typical applications. However, various combinations and modifications of the features consistent with the teachings of the present disclosure may be desired for applications or implementations.

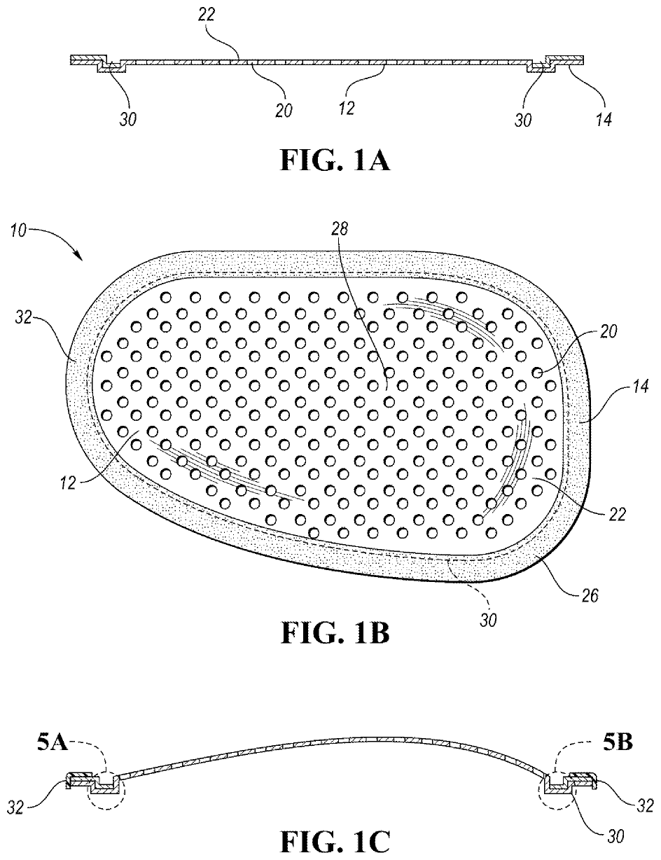

Turning first to FIGS. 1 A-C, there are depicted various aspects of a representative embodiment of a multi-tone, monolithic audio speaker cover 10 with a central region 12 and a peripheral region 14. In some embodiments, the central region has a generally planar surface. In other embodiments the central region 12 may be convex or concave. The audio speaker cover cooperates with a housing (not shown) and an audio speaker (also not shown) mounted in the housing,

In a preferred embodiment, the audio speaker cover 10 defines a plurality of apertures 20. Lands 22 lie between at least some of the apertures 20 (FIG. 1 B).

With primary reference to the embodiment shown in FIG. 1 B, a facing surface of the audio speaker cover 10 can be imagined to have a total surface area (A), the peripheral masked (protected) area 14 to have a total area (P) and a central unmasked (unprotected) area 28 (U), such that

A=P+U.

As illustrated in FIG. 1 B, one approach is to have the protected area 26 deployed around edge regions or a periphery 14 of the audio speaker cover. In such cases, P approximates to about 5-20 percent of A.

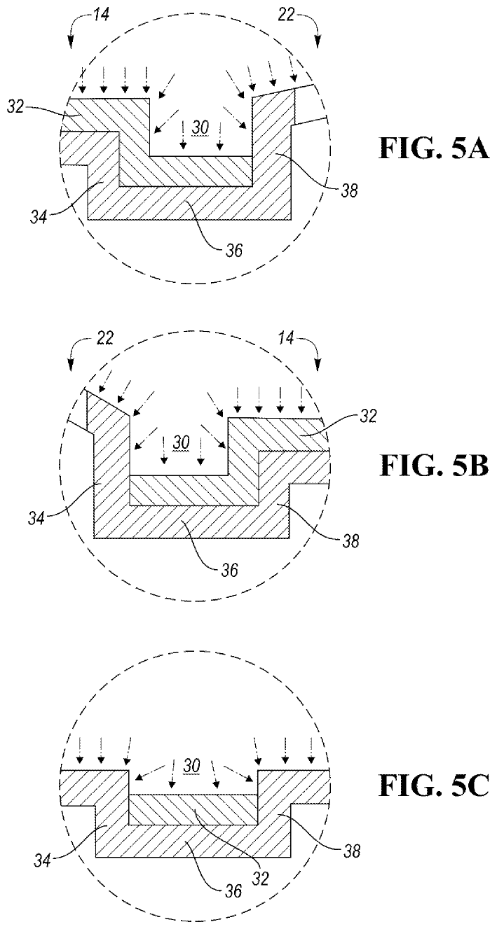

In FIGS. 1 B-C, a masking material 32 overlies at least a portion of a ditch 30 (see further enlarged detail shown in FIGS. 5 A-C, discussed later).

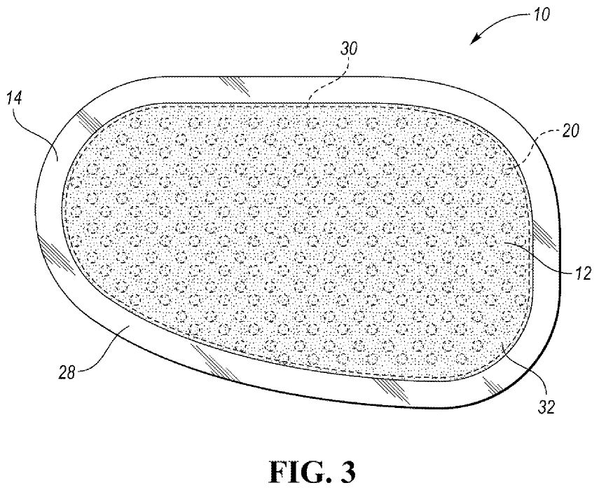

FIGS. 3-12 illustrate alternative embodiments and views of a multi-tone audio speaker cover 10. In one embodiment (FIG. 3), the masking material 32 protects a central area 12, rather than a peripheral region 14 of the shaped speaker cover 10. In that case, the unprotected area 28 lies around the periphery 14 of the shaped speaker cover.

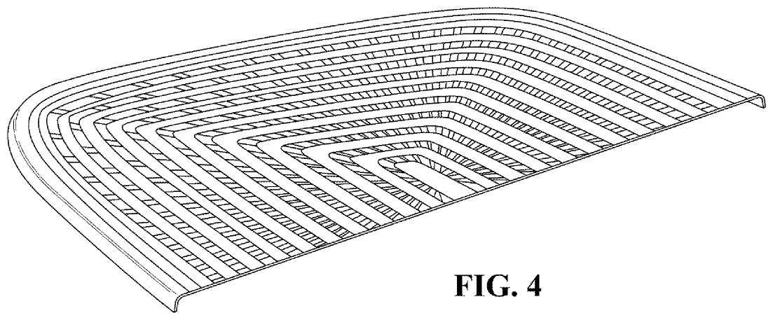

Referring now to FIGS. 4-5, let “D” represent the depth of the ditch 30 from the floor 36 to the intersection between the outer ditch wall 34 and the surface of the shaped blank, and “T” represent the thickness of the shaped blank. Then

D>0.5×T.

For example, if D=0.012 ins. and T=0.020 ins., the depth (D) preferably exceeds one half of the shaped blank thickness (T).

A preferred way of making the ditch is to etch the ditch from the topside only of a metal blank. The bottom side of the metal blank is protected with a resident coating. Holes are etched from both the top and bottom surfaces of the metal blank at the same time. There is no resident coating on the top or bottom surfaces where the holes are etched. This allows the acid to remove material from both sides of the metal blank to create a through-hole.

It will be appreciated that further alternative speaker cover appearances can be created by suitable deployment of masking material and selection of surface treatments. Such appearances could for example include islands or a pattern of a secondary treatment, tone or color positioned atop or adjacent to a base of a primary treatment or color. As used herein “treatment” or “treating” includes painting, anodizing, burnishing, anodizing with a tinted anodizing solution, plastic vapor deposition coating and other thin film deposition techniques.

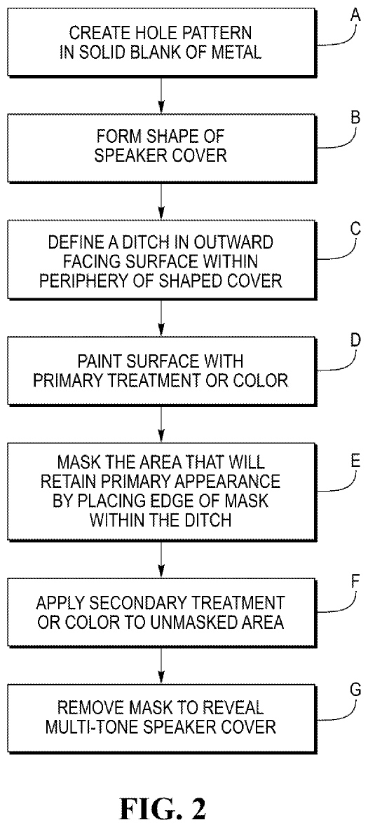

In more process detail (FIG. 2), it is to be appreciated that the audio speaker cover cooperates with a housing and an audio speaker mounted in the housing. Exemplary ways to make the desired multi-tone, one-piece audio speaker covers might involve the following process steps:

a. creating a hole pattern in a blank—this step may begin with taking a solid, preferably planar blank of for example stainless steel or aluminum or a ceramic. Other suitable materials include low carbon steel (hot or cold rolled), plastics, carbon fiber and other ceramics. Representative thicknesses may be about 0.010-0.030 inches. The individual holes 20 may be slotted, rounded or be a combination thereof. One, but not the only, way to form such holes and the ditch 30 may be by acid etching. If desired, the ditch may be etched in the same operation as etching to form holes. Such steps occur before a subsequent masking step (described below). Optionally the surface of the blank may be treated before subsequent handling, e.g. by burnishing to impart a textured appearance;

b. forming a shape in the blank to make a shaped blank—this step may call for a planar or concave or convex-shaped central region. The footprint (outside edge) of the blank may be of any desired shape, e.g., circular, oval, quadrilateral, etc;

c. defining a ditch 30 in a peripheral region 14 of the shaped blank, inside the outside edge. It is to be appreciated that other ditch locations may be preferred, e.g. in a part of the central region. Further, this disclosure is not limited to one ditch per shaped bank, because in some situations there may be multiple ditches and multiple tones. Each ditch 30 (see FIGS. 4, and 5 A-C) serves to sharply demarcate a tone, color or texture of surfaces lying on either side of the ditch. Preferably the ditch 30 has a square or rectangular cross section that is defined by an outer wall 34, an inner wall 38 and a floor 36 therebetween. To enable a sharp demarcation between selected tones to be made, the walls and floor meet substantially perpendicularly. Optionally the ditch may assume the form of a raised region. In either case, the ditch serves to support a masking material 32 and treatment that demarcates the primary and secondary areas, thus forming a distinct break point or visual separation therebetween. In practice, the ditch may be formed by acid etching;

d. treating at least some of the surface of the shaped blank with a primary treatment, tone or color to prepare a treated or toned or colored shaped blank—this step may call for applying a clear coat by conventional techniques. In this step, usually the entire surface of the outer-facing side of the speaker cover is treated;

e. protecting an area of the treated shaped blank with the masking material 32 extending into a part of the ditch 30 (see FIGS. 5 A-C) to cover at least a portion of the treated shaped blank. This step defines a protected area 26 of the treated shaped blank that underlies the masking material 32. The protected area 26 lies adjacent to or includes at least a part of the ditch 30, on the other side of which lies an unprotected area 28 of the treated shaped blank. Preferably the masking material 32 has a linear edge that extends into at least a portion of the ditch 30. Optionally, the masking material 32 may extend to the foot of the outer wall 34 at the floor 36 (FIG. 5B). Alternatively, the masking material may extend to the foot of the inner wall 38 and the floor 36 (FIG. 5A). In some cases, it may be desirable to cover the floor 36 alone (FIG. 5C). Optionally, the masking material in FIG. 5 A may have an edge that aligns with the foot of the outer wall 34. Optionally, the masking material in FIG. 5 B may have an edge that aligns with the foot of the inner wall 38. It is to be appreciated that the masking material 32 may be re-usable. Optionally, re-masking and re-treating or re-painting can be undertaken if one or more additional surface textures or colors are required;

f. applying a secondary treatment, tone, or color (e.g. a darker color) to the unprotected area. In such cases, a two-tone effect is created in which the periphery preferably is of a lighter surface appearance than the central region, which is usually darker;

g. removing the masking material without deteriorating the protected area or the unprotected area or the ditch to define a distinct, crisp, and unwavering separation between the primary and secondary treated, toned, or colored areas, which is visually pleasing. No distractions caused by wavering lines or surface blemishes are presented.

Manufacturing economies are realized by practicing such process steps. A one-piece audio speaker cover is created without needing to follow more numerous process steps in which for example a chrome periphery circumscribes a central region. Further, problems associated with buzzes, squeaks and rattles in a multi-piece assembly are avoided.

It will be appreciated that in some embodiments, the central region 12 may be convex, bulging outwardly. Alternatively, the central region 12 may be substantially concave or planar.

Preferably, the speaker cover 10 has an outer surface that is substantially free of unwanted blemish or tarnish produced by manufacturing idiosyncrasies.

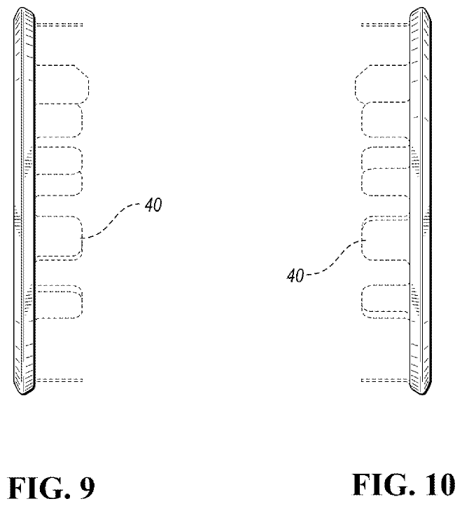

FIGS. 9-12 illustrate attachment features 40 that enable the speaker cover to cooperate with a housing (not shown).

While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

TABLE OF REFERENCE NUMBERS

| Reference No. | Component |
|---|---|
| 10 | Speaker Cover |
| 12 | Central Region |
| 14 | Peripheral Region |
| 20 | Apertures |
| 22 | Lands |
| 26 | Protected Area |
| 28 | Unprotected Area |
| 30 | Ditch |
| 32 | Masking Material |
| 34 | Outer Ditch Wall |
| 36 | Ditch Floor |
| 38 | Inner Ditch Wall |
| 40 | Attachment Features |

What is claimed is:

1. A method of making a multi-tone monolithic audio speaker cover, the method being practiced in a manufacturing environment in which multiple audio speaker covers are prepared in batch, the method comprising the steps of:
creating a hole pattern in a planar blank taken from a batch of multiple planar blanks, the planar blank having a surface area that at least partially protects an audio speaker in cooperation with a housing that accommodates an audio speaker and the audio speaker cover;
defining a ditch in a peripheral region of the planar blank, the ditch having an inner wall positioned proximate a central region thereof, an outer wall positioned proximate the peripheral region and a floor extending between the outer and inner walls so that an inner ditch edge is formed between the inner wall and the floor, an outer ditch edge is formed between the outer wall and the floor, one of the inner and outer ditch edges being adapted to demarcate a boundary between primary and secondary areas of the shaped blank;
forming a shape in the planar blank to make a shaped blank having a peripheral region and a central region;
treating at least some of a surface of the shaped blank with a primary treatment, tone, or color to prepare a treated surface of the shaped blank;
shielding an area of the treated surface with a masking material that covers at least a portion of the peripheral or the central region and the ditch, thereby defining a protected area of the treated shaped blank that underlies the masking material, the protected area lying adjacent to an unprotected area of the treated shaped blank located across the ditch, the masking material extending to an inner ditch edge or an outer ditch edge or at least a portion of the floor;
applying a secondary treatment or color to the unprotected area;
optionally, re-masking, re-treating, or re-painting if one or more additional treatments or colors or tones are required; and
removing the masking material without deteriorating the protected area or the ditch to define a distinct border along an edge or floor of the ditch between the primary and secondary treatments or colors or tones, thereby creating an audio speaker cover that is free of blemishes and has a visually pleasing, distinct separation between the primary and secondary treatments or tones or colors.

2. The method of claim 1, wherein the inner ditch wall is perpendicular to the floor.

3. The method of claim 1, wherein the outer ditch wall is perpendicular to the floor.

4. The method of claim 1, wherein an edge of the masking material is placed at the inner ditch edge.

5. The method of claim 1, wherein an edge of the masking material is placed at the outer ditch edge.

6. The method of claim 1, wherein an edge of the masking material is placed along a part of the floor.

7. The method of claim 1, wherein a boundary between the primary and secondary treatment areas of the shaped blank lies at the inner ditch edge.

8. The method of claim 1, wherein a boundary between the primary and secondary treatment areas of the shaped blank lies at the outer ditch edge.

9. The method of claim 1, wherein a boundary between the primary and secondary treatment areas of the shaped blank lies on the floor.

10. The method of claim 1, wherein the blank includes a material selected from the group consisting of stainless steel, low carbon steel that is hot- or cold-rolled, aluminum, plastic, wood, carbon fiber and another ceramic.

11. The method of claim 1, wherein the multi-tone audio speaker cover includes a two-tone audio speaker cover.

12. The method of claim 1, wherein the shaped blank includes a central region that is configured by selecting a topography selected from the group consisting of at least partially convex, substantially planar, and at least partially concave.

13. The method of claim 1, wherein the shaped blank includes a periphery that has a configuration selected from the group consisting of round, quadrilateral, trapezoidal, oval and combinations thereof.

14. The method of claim 1, wherein the treatment step calls for treating at least a part of one side of the shaped blank with a primary finishing material.

15. The method of claim 14, wherein the primary finishing material is a clear coat.

16. The method of claim 1 wherein the masking step involves covering a peripheral region of the shaped blank.

17. The method of claim 1 wherein the masking step involves covering a central region of the shaped blank.

18. The method of claim 1, wherein the primary treatment or color is darker than the secondary treatment or color.

19. A multi-tone, one-piece monolithic audio speaker cover having:
a shaped blank having a primary area with a first tone, texture or appearance and a secondary area having a second tone, texture, or appearance;
a ditch having an inner wall proximate a central region, an outer wall proximate the peripheral region and a floor extending between the outer and inner walls so that an inner ditch edge is formed between the inner wall and the floor, an outer ditch edge is formed between the outer wall and the floor, the ditch extending along a boundary between the central and peripheral regions; and
a distinct unwavering line of demarcation between the primary and secondary area, the line lying along an edge of the ditch.

20. An intermediate product formed in making a multi-tone, monolithic audio speaker cover, the intermediate product having:
a shaped blank with apertures and a surface area with lands between apertures that at least partially protects an audio speaker in cooperation with a housing that accommodates the audio speaker and the audio speaker cover, the shaped blank having a peripheral region and a central region;
primary and secondary areas of the shaped blank that respectively have primary and secondary treatments;
a ditch having an inner wall positioned proximate a central region of the shaped blank and an outer wall positioned proximate a peripheral region of the shaped blank, and a floor extending between the outer and inner walls, the ditch separating the peripheral and central regions, the ditch being adapted to serve with multi-toned treatments on either side of the ditch to form a visually distinct boundary between the primary and secondary areas of the shaped blank; and
a masking material that covers at least a portion of the ditch, thereby defining a protected area of the treated shaped blank that underlies the masking material, the protected area lying adjacent to an unprotected area of the treated shaped blank located on another side of the ditch, the masking material extending to an inner ditch edge or an outer ditch edge or at least a portion of the floor, the masking material being removed after the primary and secondary treatments without deteriorating the protected area or the ditch to define a distinct border along an edge or floor of the ditch between the primary and secondary treatments or colors or tones, the audio speaker cover being free of blemishes and having a visually pleasing, distinct separation between the primary and secondary treatments or tones or colors.
